(19) United States
(12) Patent Application Publication
(10) Pub. No.: US 2004/0074949 A1
(43) Pub. Date: Apr. 22, 2004

(54) Friction agitation joining method flat material for plastic working and closed end sleeve like body

(76) Inventors: Masayuki Narita, Saitama (JP); Yasuyuki Hama, Saitama (JP); Hiroshi Akiyama, Saitama (JP); Takenori Hashimoto, Tochigi (JP); Yoshitaka Nagano, Tochigi (JP); Shigetoshi Jogan, Osaka (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/469,228

(22) PCT Filed: Mar. 7, 2002
(86) PCT No.: PCT/JP02/02144

(30) Foreign Application Priority Data
Mar. 7, 2001 (JP) 2001-63304
Mar. 19, 2001 (JP) 2001-78313

(51) Int. Cl. B23K 20/12

(52) U.S. Cl. 228/112.1

(57) ABSTRACT

A friction stir welding method conducts contact welding on two welding target members having different high temperature deformation resistances by using a welding tool having a rotatable welding head, contacting the two welding target members having different high temperature deformation resistances against each other so as to generate a difference in height between the two welding target members on a surface side in a thickness direction, arranging the rotating head in a state in which the head is embedded into a contact section of the two welding target members or a neighborhood of the contact section from the surface side, and relatively moving the welding head to the two welding target members along the contact section in this state, is provided. A rotating direction of the welding head is set in a direction in which the welding head rotates from the welding target member which is higher in high temperature deformation resistance to the welding target member which is lower in high temperature deformation resistance in the rear of a welding direction and the contact welding is conducted on the two welding target members.

### TECHNICAL FIELD

The present invention relates to a friction stir welding method used to manufacture a metallic structural member in, for example, an automobile, an electronic computer, an industrial machine, or the like. The present invention also relates to a plastic work plate material suited to form a bottomed cylindrical body used as, for example, a metal pressure vessel (a bottle or can for carbonated beverages such as beer, a gas cylinder, or the like) or as a soft drink bottle or can, and to a bottomed cylinder body formed out of the material.

### BACKGROUND ART

A friction stir welding method, which is a type of solid state welding method, has excellent advantages in that the type of metal material used as a welding target member is not limited, thermal distortions following the generation of welding heat are extremely small, and the like. Recently, therefore, the friction stir welding has been utilized as welding means for various types of structures.

FIGS. 5 and 6 show that two welding target members which are contacted against each other while a difference in height is generated between the two members on a surface side in thickness direction, are subjected to contact welding using this friction stir welding method.

In FIGS. 5 and 6, reference numeral 51 denotes a thin, flat first welding target member, and 52 denotes a thick, flat second welding target member. The first welding target member 51 and the second welding target member 52 differ in the type of metal material and also differ in thickness. That is, as shown in FIG. 6, the first welding target member 51 has a high temperature deformation resistance of Y1′ and a thickness of t1′ whereas the second welding target member 52 has a high temperature deformation resistance of Y2′ (where Y2′ ≠Y1′) and a thickness of t2′ (where t2′>t1′).

For the convenience of description, it is assumed herein that the high temperature deformation resistance Y2′ of the second welding target member 52 is higher than the high temperature deformation resistance Y1′ of the first welding target member 51 (that is, Y2′>Y1′).

The welding target members 51 and 52′are contacted against each other on one end face 53 in width direction. In FIGS. 5 and 6, the end faces of the two welding target members 51 and 52 are contacted against each other so that the respective rear surfaces are flush with each other (contacted sections 55). Due to this, there is a difference in height between the two members 51 and 53 corresponding to the difference in thickness therebetween on the surface side. Reference numeral 54 denotes a height difference section formed on the surface at the position of the contact section 55 between the two welding target members 51 and 52 and reference numeral 54a denotes the corner of the height difference section 54.

Reference numeral 60 denotes a welding tool for friction stir welding. This welding tool 60 is a rotatable tool which consists of a large-diameter cylindrical rotator 61 and a small-diameter pin probe 62 which is protruded from the rotating central section of the end face 61a of the rotator 61 along a rotation axis Q′ and is provided integrally with the rotator 61. The probe 62 serves as a welding head 63.

If the welding target members 51 and 52 are contact-welded using this welding tool 60, the materials of the welding target members 51 and 52 softened by frictional heat spatter around from the neighborhood of the probe 62 of the welding tool 60 due to the difference in height between the contacted sections 55 of the members 51 and 52. As a result, poor welding tends to occur following a shortage of stock and poor welding also tends to occur following a shortage of the quantity of frictional heat generated, thereby disadvantageously making it difficult to form a good welded section W′.

To overcome these disadvantages, the following method is proposed in Japanese Patent Application Laid-Open No. 10-249553, as shown in FIG. 6. The probe 62 of the rotating welding tool 60 is arranged to be embedded into the contact section 55 and the rotator 61 is arranged so that the rotation axis Q′ of the rotator 61 is inclined relative to the two welding target members 51 and 52 toward the welding target member at a lower position (i.e., the first welding target member 1). In this state, the probe 62 is relatively moved to the two welding target members 51 and 52 along the contact section 55, whereby the welding target members 51 and 52 are contact-welded. In this figure, M′ donates a welding direction and R′ donates a rotating direction of the rotator 61.

According to the proposed method, the stocks of the welding target members 51 and 52 spattering around in the neighborhood of the probe 62 can be deflected by the end face 61a of the rotator 61 or be contained at the end face 61a of the rotator 61, thereby making it advantageously possible to prevent the occurrence of poor welding caused by the shortage of stock. In addition, the tilt angle θ of the rotation axis Q′ of the rotator 61 to the first welding target member 51 is appropriately changed, thereby making it advantageously possible to appropriately adjust the quantity of generated frictional heat and to prevent the occurrence of the poor welding caused by a shortage of frictional heat. Furthermore, according to this proposed method, the end face 61a of the rotator 61 is pressure-welded to the shoulder section 52a of the welding target member at a higher position (i.e., the second welding target member 52) protruded from the contact section 55, whereby the shoulder section 52a can be plastically deformed so that the surface of the shoulder section 52a becomes an inclined surface. As a result, it is advantageously possible to ease the concentration of stress generated in the height difference section 54 in a resultant contact welded joint. Reference symbol P′ denotes the normal line of the surfaces of welding target members 51 and 52 at the probe embedded position.

Meanwhile, in the friction stir welding, an edge located at a position at which the rotation direction R′ of the rotator 61 and the welding direction M′ are consistent with each other on the internal peripheral edge of the welded section W′ is normally referred to as an “advanced edge” whereas an edge located at an opposite position to this advanced edge is referred to as a “retreating edge”.

Generally, the friction stir welding has a disadvantage in that a cavity tends to occur in the vicinity of the advanced edge of the welded section W′. This cavity is a welding defect which is continuously formed in the rear of a probe moving direction following the movement of the probe 62 and is referred to as a tunnel welding defect. This tunnel welding defect occurs because the stock of the second welding target member 2 does not sufficiently plastically flow on the advanced edge side.

Therefore, according to the above-stated proposed method, if the rotating direction of the rotator 61 of the welding tool 60 is set in the direction R′ in which the rotator 61 rotates from the first welding target member 51 which is lower in high temperature deformation resistance to the second welding target member 52 which is higher in high temperature deformation resistance and contact welding is performed in the rear of the welding direction M′ as shown in FIG. 5, then not only do tunnel welding defects tend to occur in the vicinity of the advanced edge of the welded section W as already stated, but also it is more difficult to cause the stock of the second welding target member 52, which is arranged on the advanced edge side and which is higher in high temperature deformation resistance Y2′, to plastically flow. As a result, the proposed method has a disadvantage in that the probability of the occurrence of the tunnel welding defect is extremely high.

Particularly if the welding target members 51 and 52 are contacted against each other while there is a difference in height in the thickness direction between the two members 51 and 52, the air present in the corner 54a of the height difference section 54 is entrained into the welded section W′ during the welding, with the result that the probability of the occurrence of such a tunnel welding defect further increases.

Moreover, the metal pressure vessel such as a carbonated drink bottle or can for beer or the like, or a gas cylinder, for example, is exclusively formed by drawing, such as deep drawing, which is a kind of plastic working. This is because it is possible to form a pressure vessel without joints by the drawing.

As for such a pressure vessel, the wall thicknesses of the bottom wall section and the top wall section of the vessel are preferably formed to be larger than that of the peripheral wall section of the vessel so as to satisfy the required strength of the pressure vessel.

Nevertheless, a drawing material is normally a plate having uniform wall thickness. Due to this, if such a pressure vessel is to be formed using this material, it is required to perform drawing so that the wall thicknesses of the bottom wall section and the top wall section of the pressure vessel become larger than that of the peripheral wall section, which disadvantageously requires high-level working technique.

The present invention has been made in light of the above-stated technical background. A first object of the present invention is to provide a friction stir welding method for contact welding two welding target members different in high temperature deformation resistance, which method is capable of suppressing the occurrence of a tunnel welding defect following the shortage of plastic flow even if the welding target members are contacted against each other while a difference in height between the members is generated on a surface side in thickness direction.

A second object of the present invention is to provide a plastic work plate material which allows a workpiece having a thick wall section and a thin wall section to be easily formed and which has excellent workability, and to provide a bottomed cylindrical body formed out of the material.

### DISCLOSURE OF THE INVENTION

The first feature of the present invention relates to a friction stir welding method. The invention recited in claim 1 is a friction stir welding method for conducting contact welding by: using a welding tool having a rotatable welding head; contacting two welding target members having different high temperature deformation resistances against each other so as to generate a difference in height on a surface side in a thickness direction; arranging the rotating welding head to be embedded into a contacted section of the two welding target members or a neighborhood of the contacted section from the surface side; and in this state, relatively moving the welding head to the two welding target members along the contacted section, and is characterized in that a rotating direction of the welding head is set in a direction in which the welding head rotates from the welding target member which is higher in high temperature deformation resistance to the welding target member which is lower in high temperature deformation resistance rearward of a welding direction and the contact welding is conducted on the two welding target members.

According to this friction stir welding method, the rotating direction of the welding head is set in a direction in which the welding head rotates from the welding target member which is higher in high temperature deformation resistance to the welding target member which is lower in high temperature deformation resistance rearward of the welding direction, whereby the welding target member lower in high temperature deformation resistance out of the two welding target members is arranged at the advanced edge side. As a result, during the welding, the stock of the welding target member softened by frictional heat swiftly and plastically flows in response to a rotating force from the welding head, thereby suppressing the occurrence of a tunnel-like welding defect.

In the present invention, the comparison of the magnitude of the high temperature deformation resistances of the two welding target members is made based on deformation resistances at a welding temperature. To be specific, if the two welding target members are made of aluminum or aluminum alloy, the high temperature deformation resistances of the two welding target members are compared based on the average deformation resistances thereof, preferably in a temperature range of 200 to 600° C., and most preferably in a temperature range of 400 to 550° C. By doing so, it is possible to ensure suppressing the occurrence of a tunnel-like welding defect.

The invention as recited in claim 2 is a friction stir welding method for conducting contact welding on two welding target members by: using a welding tool having a rotatable welding head; contacting a first welding target member having a high temperature deformation resistance of Y1 and a wall thickness of t1 and a second welding target member having a high temperature deformation resistance of Y2 (wherein Y2≠Y1) and a wall thickness of t2 against each other so as to generate a difference in height on a surface side in a thickness direction; arranging the rotating welding head to be embedded into a contact section of the two welding target members or a neighborhood of the contact section from a surface side; and in this state, relatively moving the welding head to the two welding target members along the contact section, and is characterized in that when the two welding target members are contacted against each other while satisfying a relational expression of Y2×t2<Y1×t1, a rotating direction of the welding head is set in a direction in which the welding head rotates from the first welding target member to the second welding target member rearward of a welding direction and the contact welding is conducted at the two welding target members; and when the two welding target members are contacted against each other while satisfying a relational expression of Y2×t2>Y1×t1, the rotating direction of the welding head is set in a direction in which the welding head rotates from the second welding target member to the first welding target member rearward of the welding direction and the contact welding is conducted on the two welding target members.

According to this friction stir welding method, by setting the rotating direction of the welding head while considering the wall thicknesses of the two welding target members in addition to the high temperature deformation resistances thereof, it is possible to ensure suppressing the occurrence of a tunnel-like welding defect.

The invention as recited in claim 3 is a friction stir welding method according to claim 1 or 2, wherein the welding head of the welding tool consists of a small-diameter probe protruded from an end face of a large-diameter rotator, the rotating rotator is arranged in a state in which a rotation axis of the rotator is inclined relatively to the two welding target members toward the welding target member at a lower position and in a state in which an end face of the rotating rotator is pressure-welded to a shoulder section of the welding target member at a higher position protruded from the contact section, and the contact welding is conducted in this state.

According to this method, by arranging the rotator of the welding tool in a state in which the rotation axis of the rotator is inclined relatively to the two welding target members toward the welding target member on a lower position side, it is possible to reflect the stocks of the two welding target members which are spattering around in the vicinity of the probe by the end face of the rotator or to contain them in the end face of the rotator, and to thereby prevent poor welding following the shortage of stock.

Furthermore, by arranging the end face of the rotator to be pressure-welded to the shoulder section of the welding target member on a higher position side, it is possible to plastically deform the shoulder section so that the surface of the shoulder section becomes an inclined surface on the end face of the rotator. As a result, it is possible to ease the concentration of stress which occurs at the height difference section of a contact welded joint to be obtained. In addition, by appropriately changing the tilt angle of the rotation axis of the rotator with respect to the welding target member on the lower position side or appropriately changing the outside diameter of the end face of the rotator, it is possible to appropriately adjust the quantity of generated frictional heat and to thereby prevent the occurrence of poor welding following a shortage of frictional heat.

Moreover, by pressure-welding the end face of the rotator to the shoulder section of the welding target member on the higher position side, the quantity of generated frictional heat increases. By receiving this increased frictional heat, the stock of the welding target member located on the advanced edge side plastically flows further swiftly. As a result, it is possible to further ensure suppressing the occurrence of a tunnel-like welding defect.

The invention as recited in claim 4 is a friction stir welding method for conducting contact welding on two welding target members by: using a welding tool having a rotatable welding head consisting of a small-diameter probe protruded from an end face of a large-diameter rotator; contacting a first welding target members having a high temperature deformation resistance of Y1 and a wall thickness of t1 and a second welding target member having a high temperature deformation resistance of Y2 (wherein Y2≠Y1) and a wall thickness of t2 against each other so as to generate a difference in height on a surface side in a thickness direction by arranging the second welding target member at higher position, the two welding target members satisfying a relational expression of Y2×t2>Y1×t1 in this contacted state; arranging the rotating probe to be embedded into a contact section of the two welding target members or a neighborhood of the contact section from a surface side; and arranging the rotating rotator in a state in which a rotation axis of the rotator is inclined relatively to the two welding target members toward the first welding target member and in a state in which an end face of the rotating rotator is pressure-welded to a shoulder section of the second welding target member protruded from the contact section, and in this state, relatively moving the probe to the two welding target members along the contact section, is characterized in that a rotating direction of the welding head is set in a direction in which the welding head rotates from the second welding target member to the second welding target member rearward of a welding direction and the contact welding is conducted on the two welding target members.

According to this friction stir welding, the stock of the first welding target member located on the advanced edge side swiftly and plastically flows for the same reason as that of claim 3. As a result, it is possible to further ensure suppressing the occurrence of a tunnel-like welding defect.

Furthermore, the stock of the shoulder section of the second welding target member pressure-welded to the end face of the rotator receives a pressure-welding force from the end face of the rotator and the rotating force of the rotator and thereby plastically flows toward the first welding target member. As a result, the stock of the shoulder section can be efficiently filled in the corner of the height difference section, thereby increasing the welding strength of a contact welded joint to be obtained.

Next, the second feature of the present invention relates to a plastic work plate material which is characterized by comprising a thick wall section and a thin wall section, and it is characterized in that the thick wall section and the thin wall section are welded and integrated by friction stir welding.

According to this material, plastic working is conducted on this material so that the thick wall section and the thin wall section thereof become the thick wall section and the thin wall section of a workpiece to be obtained, respectively. It is, therefore, possible to easily form a workpiece comprising a thick wall section and a thin wall section. In addition, the friction stir welding is a kind of solid state welding and has advantages in that deformations such as thermal distortions caused by welding are extremely small and the deterioration of the mechanical characteristics caused by the welding heat of the materials to be welded is extremely small. Therefore, by welding and integrating the thick wall section and the thin wall section by this friction stir welding, it is possible to obtain a material prevented or suppressed from having deformations such as thermal deformations caused by the welding. In addition, the thick wall section and the thin wall section are welded and integrated without deteriorating the workability of the welded section or a region in the vicinity of the welded section. In addition, according to the friction stir welding, even if a height difference section is formed along a to-be-welded section on the surface-of the to-be-welded section, the to-be-welded section can be welded so that the surface thereof becomes an inclined surface. Therefore, by welding and integrating the thick wall section and the thin wall section by this friction stir welding, it is possible to ease the concentration of stress which may occur in the height difference section formed in the abutment section between the thick wall section and the thin wall section if the material is plastically worked and to thereby improve the workability of the material. Accordingly, by plastically working this material, it is possible to form a workpiece having excellent quality. While the material according to the present invention can be widely applied as various types of plastic work materials, the material is particularly suited as a material for drawing such as deep drawing or spinning.

Furthermore, in the plastic work plate material stated above, it is preferable that the thin wall section be formed around the thick wall section, that the thick wall section be a region for forming a bottom wall section or a top wall section, and that the thin wall section be a region for forming a peripheral wall section.

This material is plastically worked so that the thick wall section becomes the bottom wall section or the top wall section of a workpiece to be obtained and that the thin wall section becomes the peripheral wall section of the workpiece. Therefore, by plastically working this material, a workpiece having excellent quality and comprising a thick bottom or top wall section and a thin peripheral wall section can be obtained and the material can be used particularly suitably as a material for forming a pressure vessel containing a pressure fluid.

The present invention relates to a bottomed cylindrical body characterized by being formed by plastically working the plastic work plate material having the second feature of the present invention.

In this case, it is possible to obtain a bottomed cylindrical body having excellent quality.

### BRIEF DESCRIPTION OF THE DRAWINGS

FIG. 1 is a view showing a friction stir welding method in one mode for carrying out the first feature of the present invention, where FIG. 1(A) is a perspective view showing a state in which two welding target members are being welded, and FIG. 1(B) is an enlarged cross-sectional view of important parts taken along line I-I;

FIG. 2 is an enlarged cross-sectional view of important parts taken along line II-II of FIG. 1(A);

FIG. 3 is an enlarged cross-sectional view of important parts taken along line III-III of FIG. 1(A);

FIG. 4 is a view corresponding to FIG. 3 and showing a state after the two welding target members are welded;

FIG. 5 is a view showing a conventional friction stir welding method and is a perspective view showing a state in which two welding target members are being welded;

FIG. 6 is an enlarged cross-sectional view of important parts taken along line VI-VI of FIG. 5;

FIG. 7 is a view showing a bottomed cylindrical body in the First Embodiment of the second feature of the present invention, where FIG. 7(A) is a perspective view and FIG. 7(B) is a cross-sectional view;

FIG. 8 is a view showing a state before a plastic work plate material for forming the bottomed cylindrical body is subjected to welding, where FIG. 8(A) is a plan view of the material, FIG. 8(B) is a cross-sectional view taken along line XIII-XIII of FIG. 8(A), and FIG. 8(C) is an enlarged cross-sectional view of a section A shown in FIG. 8(B);

FIG. 9 is a view showing a state in which the material is being subjected to welding, where FIG. 9(A) is a perspective view of the material and FIG. 9(B) is an enlarged cross-sectional view of the important parts of the material;

FIG. 10 is a view showing a state after the material is subjected to welding, where FIG. 10(A) is a perspective view of the material, FIG. 10(B) is a cross-sectional view taken along line X-X of FIG. 10(A), and FIG. 10(C) is an enlarged cross-sectional view of a section B shown in FIG. 10(B);

FIG. 11 is a view showing a bottomed cylindrical body in the second mode for carrying out the second feature of the present invention, where FIG. 11(A) is a perspective view and FIG. 11(B) is a cross-sectional view;

FIG. 12 is a view showing a state before a plastic work plastic material for forming the bottomed cylindrical body is subjected to welding, where FIG. 12(A) is a plan view of the material, FIG. 12(B) is a cross-sectional view taken along line XII-XII of FIG. 12(A), FIG. 12(C) is an enlarged cross-sectional view of a section C shown in FIG. 12(B), and FIG. 12(D) is an enlarged cross-sectional view of a section D shown in FIG. 12(B); and

FIG. 13 is a view showing a state after the material is subjected to welding, where FIG. 13(A) is a plan view of the material, FIG. 13(B) is a cross-sectional view taken along line XIII-XIII of FIG. 13(A), FIG. 13(C) is an enlarged cross-sectional view of a section E shown in FIG. 13(B), and FIG. 13(D) is an enlarged cross-sectional view of a section F shown in FIG. 13(B).

### BEST MODES FOR CARRYING OUT THE INVENTION

Modes for carrying out the present invention will next be described with reference to the drawings.

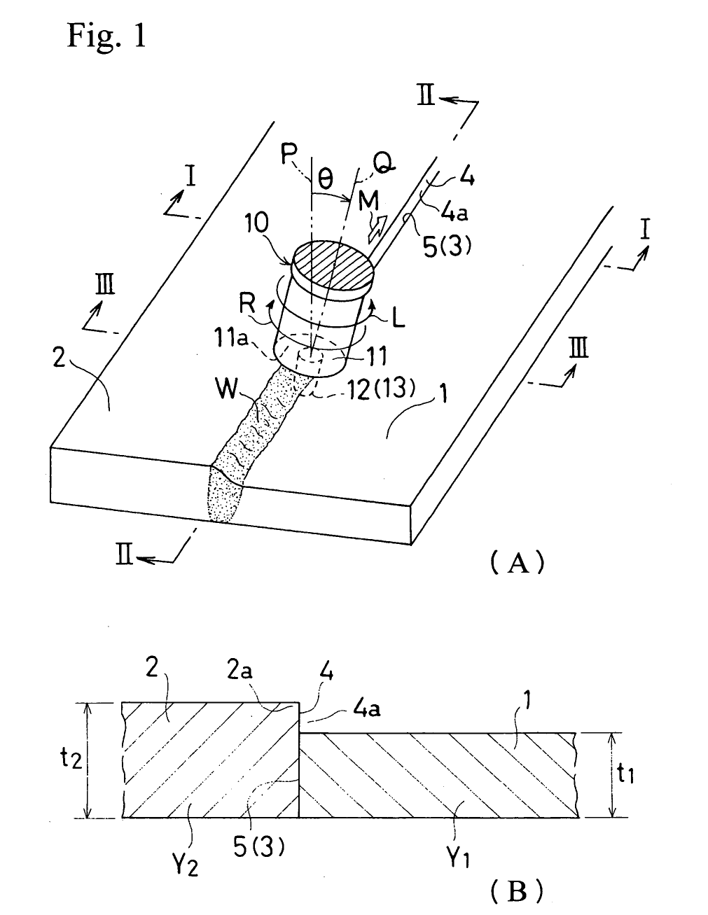

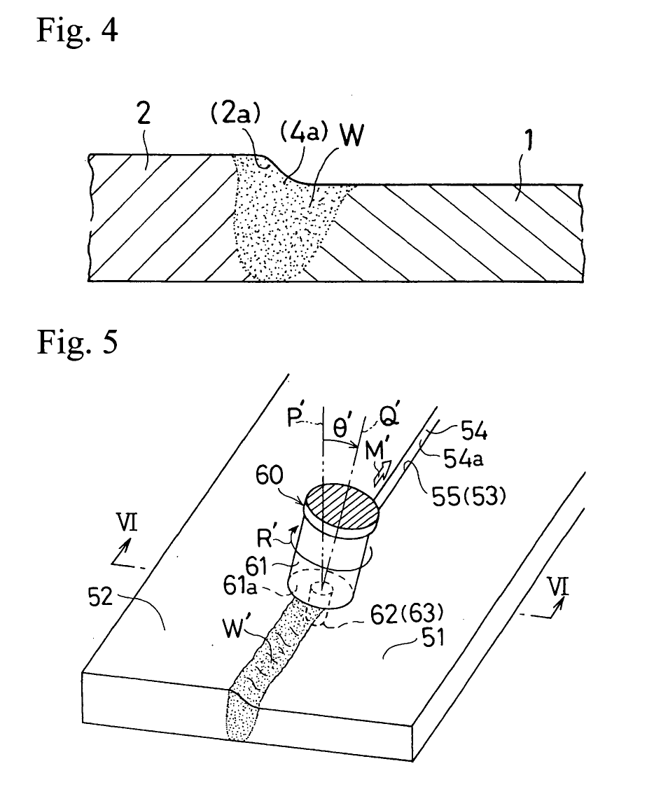

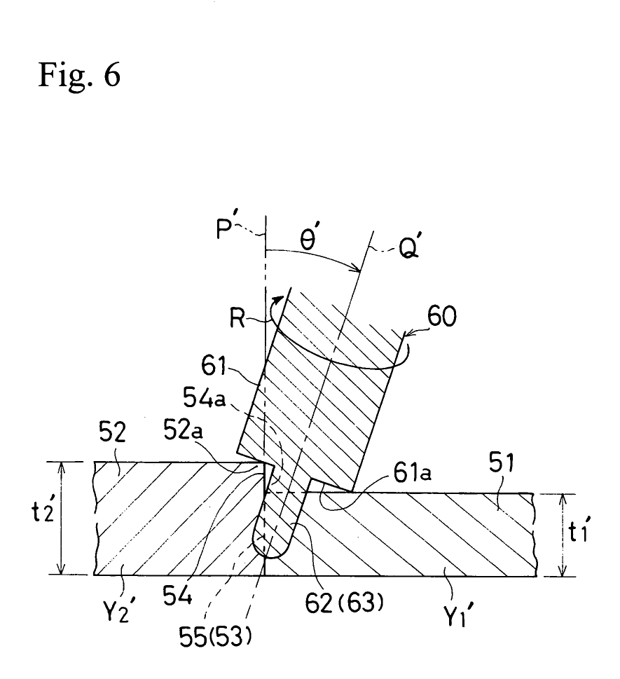

FIGS. 1 to 4 show one mode for carrying out the first feature of the present invention. A contact welded joint obtained by friction stir welding in this mode for carrying out the first feature of the invention is used as the tailored blank material of an automobile.

In FIG. 1, reference numeral 1 denotes a thin, longitudinal, plane first welding target member and 2 denotes a thick, longitudinal, plane second welding target member.

The first welding target member 1 and the second welding target member 2 are made of different types of aluminum or aluminum alloy. Because of this, they are different in high temperature deformation resistance. In addition, the two welding target members 1 and 2 differ in wall thickness.

As shown in FIG. 1(B), it is assumed herein that the high temperature deformation resistance and the wall thickness of the first welding target member 1 are Y1 and t1 and those of the second welding target member 2 are Y2 (where Y2×Y1) and t2, respectively. It is also assumed herein that t2 is larger than t1 (i.e., t2>t1).

The product of the high temperature deformation resistance Y1 and the wall thickness t1 of the first welding target member 1 (i.e., Y1×t1) corresponds to the total high temperature deformation resistance of the first welding target member 1. Likewise, the product of the high temperature deformation resistance Y2 and the wall thickness t2 of the second welding target member 2 (i.e., Y2×t2) corresponds to the total high temperature deformation resistance of the second welding target member 2.

In this mode for carrying out the first feature of the present invention, description will be given while assuming that the high temperature deformation resistance Y2 of the second welding target member 2 is higher than the high temperature deformation resistance Y1 of the first welding target member 1 (i.e., Y2>Y1) and that the total high temperature deformation resistance Y2×t2 of the second welding target member 2 is higher than the total high temperature deformation resistance Y1×t1 of the first welding target member 1 (i.e., Y2×t2>Y1×t1) for the sake of description.

The welding target members 1 and 2 are contacted against each other on one end faces 3 in width direction. The end faces 3 are formed perpendicular to the front and rear surfaces of the welding target members. The end faces 3 of the both welding target members 1 and 2 are contacted against each other (in contact section 5) while the rear surfaces thereof are flush with each other. Due to this, a difference in height is generated between the two members 1 and 2 on the surface side to correspond to a difference in wall thickness therebetween. Furthermore, a backing member (not shown) is provided at the rear surface of the contact section 5 between the first and second welding target members 1 and 2. In FIG. 1B, reference numeral 4 denotes a height difference section which is formed on the surface at the position of the contact section 5 between the welding target members 1 and 2. Reference numeral 4a denotes a corner of this height difference section 4. In addition, the welding target members 1 and 2 are contacted against each other so that the rear surfaces thereof are flush with each other. Therefore, in this contacted state, the second welding target member 2 is located on a higher position side and the first welding target member 1 is located on a lower position side.

Reference 10 denotes a welding tool for the friction stir welding. This welding tool 10 is a rotatable member, as in the case of that shown in the conventional art (see FIG. 5, reference numeral 60), which consists of a large-diameter cylindrical rotator 11 and a small-diameter pin probe 12 which is protruded from the rotating central section of the end face 11a of the rotator 11 along a rotation axis Q and is provided integrally with the rotator 11. The probe 12 serves as a welding head 13. The rotator 11 and the probe 12 are formed out of heat resistance materials which are harder than the welding target members 1 and 2 and are resistant to frictional heat generated when the members 1 and 2 are welded. In addition, a stirring convex section (not shown) for stirring the stocks of the welding target members 1 and 2 softened by the frictional heat is provided on the outer peripheral surface of the probe 12. Furthermore, at least the outer peripheral edge of the end face 11a of the rotator 11 is in a plane orthogonal to the rotation axis Q. In this mode for carrying out the first feature of the present invention, the end face 11a which is a plane face, of the rotator 11 may be depressed from the outer peripheral edge toward the rotating central portion.

If the welding target members 1 and 2 are contact welded using this welding tool, the rotator 11 of the welding tool 10 first rotates in a predetermined rotation direction (which direction will be described later) around the rotation axis Q, thereby rotating the probe 12.

Next, as shown in FIG. 3, the rotation axis Q of the rotator 11 which is rotating is inclined toward the first welding target member 1 on the surfaces of the two welding target members 1 and 2. In this state, the rotating probe 12 is embedded into the contact section 5 from the interior of the corner 4a of the height difference section 4. Furthermore, the end face 11a of this rotator 11 is pressure-welded to the shoulder section 2a of the second welding target member 2 protruded from the contact section 5 while the end face 11a strides over the welding target members 1 and 2. In FIG. 3, reference symbol P denotes the normal line of the surfaces of the welding target members 1 and 2 at a probe embedded position. In addition, reference symbol θ (where 0°<θ<90°) denotes the tilt angle of the rotation axis Q of the rotator 11 with respect to the normal line P at which the rotation axis Q is inclined toward the first welding target member 1. According to the present invention, the probe 12 may be embedded into the contact section 5 from the end faces of the welding target members 1 and 2 in a length direction. It is also possible for the probe 12 to be embedded into the contact section 2 and then for the rotation axis Q of the rotator 11 to be inclined toward the first welding target member 1. Needless to say, the state in which the rotation axis Q is inclined toward the first welding target member 1 may be realized not by inclining the rotator 11 but by fixing the attitude of the rotator 11 in a downward direction and inclining the welding target members 1 and 2 relative to the horizontal plane.

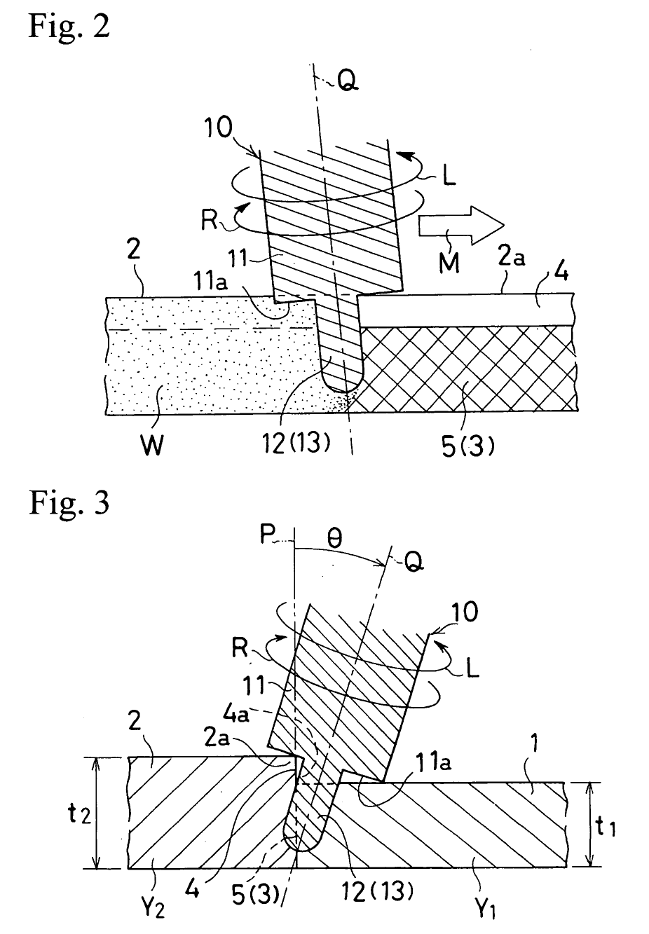

In this state, the probe 12 is moved along the contact section 5. The moving direction M of the probe 5 becomes a welding direction. At this time, as shown in FIG. 2, it is preferable that the rotation axis Q of the rotator 11 be slightly inclined toward the rear of the welding direction M, that the front section of the end face 11a of the rotator 11 in the welding direction be floated from the shoulder section 2a of the second welding target member 2, and that the probe 12 be moved in this state. By doing so, it is possible to prevent the front section of the end face 11a of the rotator 11 in the welding direction from being caught in microscopic irregularities which may be present on the surface of the shoulder section 2a of the second welding target member 2 and to thereby smoothly move the probe 12 in a predetermined direction.

Following this movement of the probe 12, the contact section 5 between the welding target members 1 and 2 is welded by the probe 12 at the probe embedded position progressively. Reference symbol W denotes a welded section.

The rotating direction of the rotator 11 will now be described.

In this mode for carrying out the first feature of the present invention, the welding target members 1 and 2 are contacted against each other so as to satisfy the relational expression of Y2×t2>Y1×t1 as already stated above. Therefore, the rotating direction of the rotator 11 is set in a direction L in which the rotator 11 rotates from the second welding target member 2 to the first welding target member 1 in the rear of the welding direction M.

By thus setting the rotating direction of the rotator 11 and contact welding the welding target members, it is possible to prevent the occurrence of a tunnel welding defect.

That is to say, the welding target members 1 and 2 are softened in the vicinity of the contact sections between the members 1 and 2 and the probe by friction heat generated following the rotation of the probe 12 and that is generated following the sliding of the end face 11a of the rotator 11 on the surfaces of the welding target members 1 and 2. The stocks of the softened parts of the welding target members 1 and 2 are stirred and mixed in response to the rotating force of the rotator 11 and that of the probe 12. In addition, the stocks plastically flow so as to fill up a groove through which the probe 12 passes following the movement of the probe 12. At this moment, since the first welding target member 1 which is located on the advanced edge side, among the first and second welding target members 1 and 2, is lower in total high temperature deformation resistance, and the stock of the first welding target member 1 swiftly, plastically flow so as to fill up the probe passage groove in response to the rotating forces of the rotator 11 and the probe 12. Due to this, stock is sufficiently, swiftly filled up in the probe passage groove. As a result, no cavity is generated not only in the vicinity of the retreating edge but also in the vicinity of the advanced edge.

While the stock is thus sufficiently, swiftly filled into the probe passage grove, the stock rapidly loses frictional heat and the stock cools and solidifies.

Furthermore, in the rear of the welding direction M, the shoulder section 2a of the second welding target member 2 receives a press-welding force from the end face 11a of the rotator 11 and is plastically deformed so that the surface of the shoulder section 2a is inclined.

The above-stated phenomena are continuously repeated following the movement of the probe 12. Finally, the welding target members 1 and 2 are welded and integrated over the entire length of the contact section 5, thereby obtaining a desired contact welded joint.

The contact welded joint thus obtained has high welding strength since the stocks of the welding target members 1 and 2 are sufficiently filled into the probe passage groove, that is, no tunnel welding defect is generated in the vicinity of the advanced edge of the welded section W.

Moreover, since this contact welded joint is formed so that the shoulder section 2a of the second welding target member 2 is plastically deformed and the surface of the shoulder section 2a becomes inclined, it is possible to ease the concentration of stress in the height difference section 4.

In addition, according to this friction stir welding, the stock of the shoulder section 2a of the second welding target member 2 softened by friction heat receives a pressure welding force from the end face 11a of the rotator 11 and the rotating force of the rotator 11 and thereby plastically flows toward the first welding target member 1. As a result, the stock of the shoulder section 2a is efficiently filled in the corner 4a of the height difference section 4. Therefore, the contact welded joint thus obtained has the stock of the shoulder section 2a sufficiently filled in the corner 4a of the height difference section 4, i.e., has high welding strength.

Moreover, according to this friction stir welding method, by pressure-welding the end face 11a of the rotator 11 to the shoulder section 2a of the second welding target member 2, it is possible to generate more frictional heat and to thereby allow the stock of the first welding target member 1 to plastically flow by this frictional heat more swiftly. It is, therefore, possible to further ensure suppressing the occurrence of the tunnel welding defect.

According to this friction stir welding method, the stocks of the both welding target members 1 and 2 spattering around in the vicinity of the probe can be reflected by the end face 11a of the rotator 11 or be contained in the end face 11a of the rotator 11, thereby preventing poor welding caused by the shortage of stock. In addition, by appropriately changing the tilt angle of the rotation axis Q of the rotator 11 toward the first welding target member 1 or appropriately changing the outside diameter of the end face 11a of the rotator 11, it is possible to appropriately adjust the quantity of generated frictional heat and to thereby prevent the occurrence of poor welding caused by a shortage of the friction heat.

The friction stir welding method in this mode for carrying out the first feature of the present invention has been described thus far in a case where the welding target members 1 and 2 are contacted against each other while satisfying the relational expression of Y2×t2>Y1×t1. Conversely, if the welding target members 1 and 2 are contacted against each other while satisfying the relational expression of Y2×t2<Y1×t1, the rotating direction of the rotator 11 is set in the direction R in which the rotator 11 rotates from the first welding target member 1 to the second welding target member 2 in the rear of the welding direction M and contact welding is performed. By doing so, it is possible to suppress the occurrence of a tunnel welding defect. The other welding procedures in this case are the same as the welding procedures stated above and will not be repeatedly described herein.

A mode for carrying out the invention has been described thus far. However, the present invention is not limited to the above-stated mode but may be variously set and modified.

In the above-stated mode, for example, welding is performed while the probe 12 of the welding tool 10 is moved along the contact section 5. Alternatively, according to the present invention, the position of the probe 12 may be fixed and the welding target members 1 and 2 may be moved and welded so that the contact section 5 sequentially passes through this probe 12. In that case, a direction opposite to the moving direction of the welding target members 1 and 2 becomes the welding direction.

A mode for carrying out the second feature of the present invention will next be described with reference to the drawings.

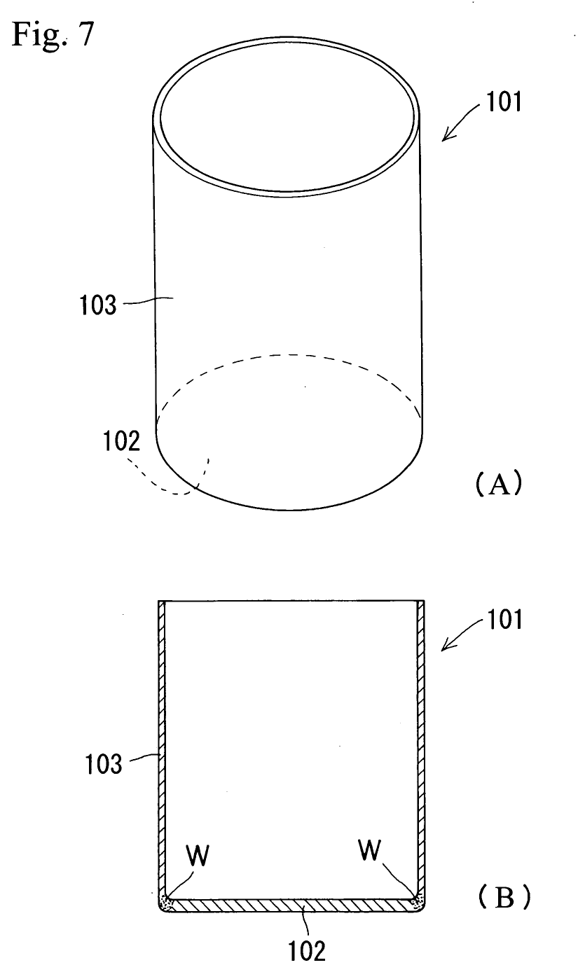

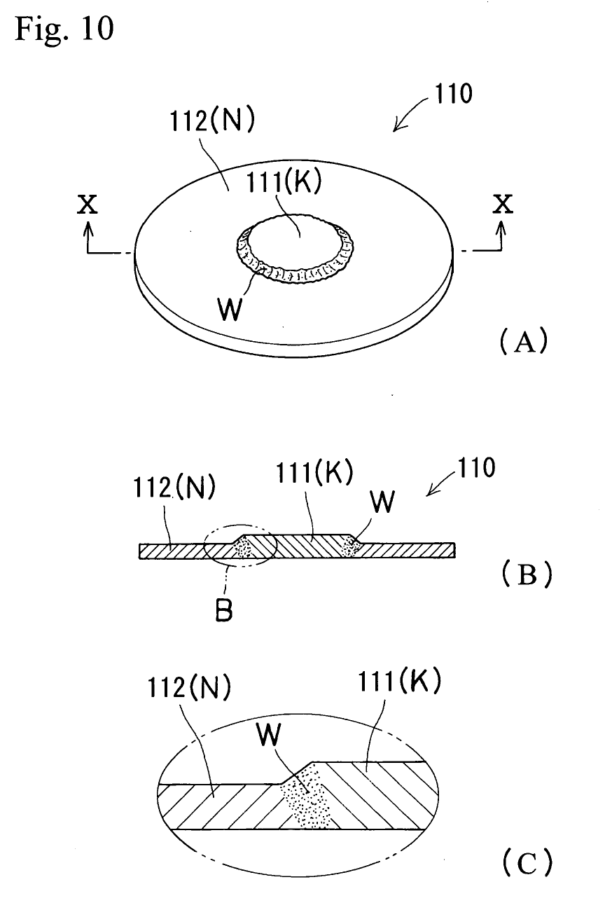

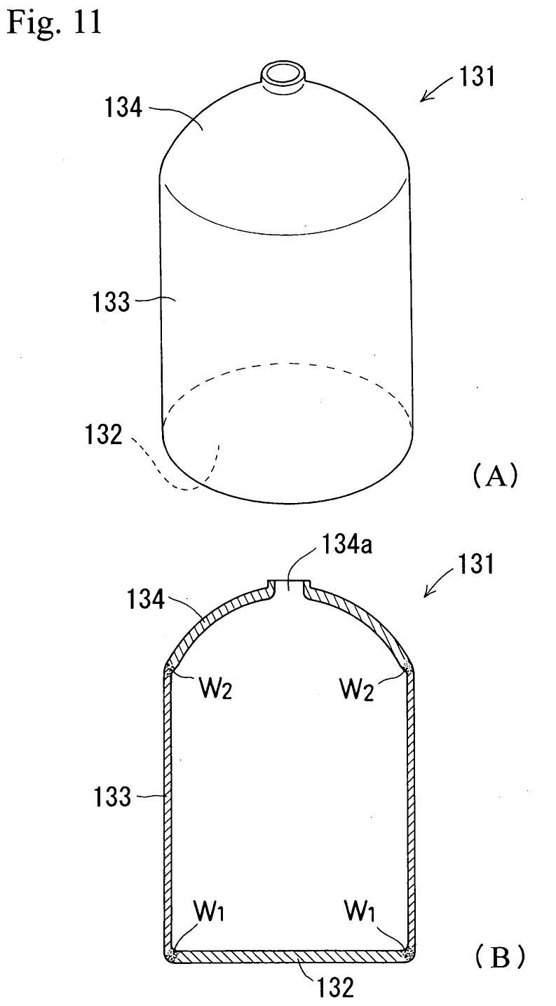

FIG. 10 shows the first mode for working a plastic work plate material according to the present invention, and FIG. 7 shows a bottomed cylindrical body formed out of this material.

The bottomed cylindrical body 101 shown in FIG. 7 is used as a pressure vessel which contains a pressure fluid, such as a carbonated drink bottle or a can for beer or the like or a gas cylinder. The bottomed cylindrical body 101 is made of aluminum or aluminum alloy and is comprised of a thick disc-shaped bottom wall section 102 and a thin cylindrical peripheral wall section 103 formed on the outer peripheral edge of the bottom wall section 102. This bottomed cylindrical body 101 is formed by subjecting a material 110 to deep drawing.

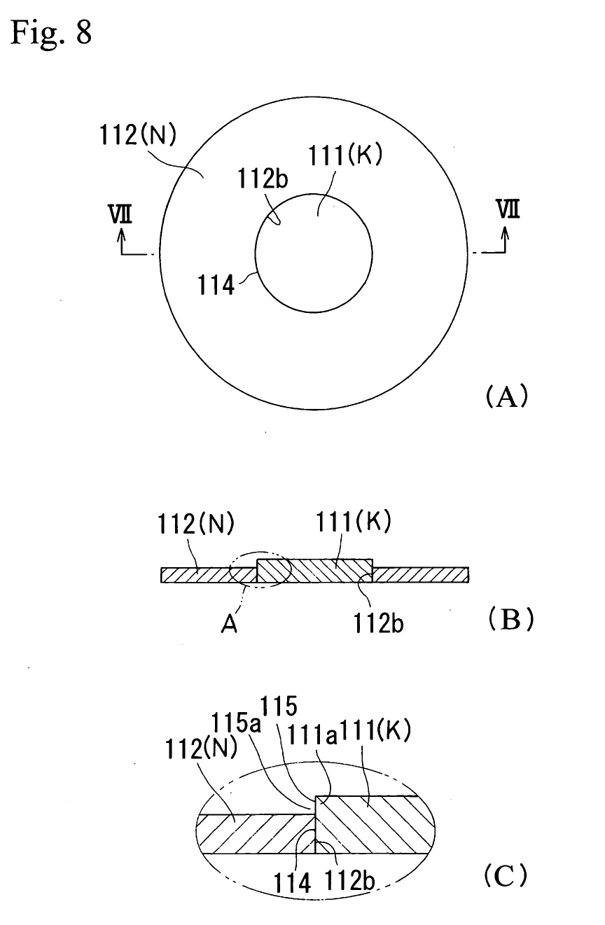

As shown in FIGS. 10(A) and 10(B), the material 110 is entirely formed into a disc, a thick wall section K is formed in the central section of the material 110 and a thin wall section N is formed around the thick wall section K. The thick wall section K is formed out of a thick, disc-like first material piece 111 of aluminum or aluminum alloy as shown in FIGS. 8(A) and 8(B). The thin wall section N is formed out of a thin, annular plate second material piece 112 made of aluminum or aluminum alloy and having a disc-like first material piece fitted hole 112b provided in a central section thereof.

In this material 110, the first material piece 111 is a region which forms the bottom wall section 102 of the bottomed cylindrical body 101, and is assumed to have a wall thickness of, for example, 5 mm, and to be made of, for example, A5083. The second material piece 112 is a region which forms the peripheral wall section 103 of the bottomed cylindrical body 101, and is assumed to have a wall thickness of, for example, 3 mm, and to be made of, for example, A5083. The first material piece 111 is exactly fitted into the fitted hole 112b of the second material piece 112 and the outer peripheral edge of the first material piece 111 and that of the fitted hole 112b of the second material piece 112 are welded (reference symbol W denotes a welded section) over the entire periphery by friction stir welding in this fitted state, whereby the first material piece 111 is integrated with the second material piece 112.

This material 110 is manufactured as follows.

That is, as shown in FIGS. 8(A) and 8(B), the first material piece 111 is fitted into the fitted hole 112b of the second material piece 112 mounted on a welding bed (not shown) so that the lower surface of the second material piece 112 is flush with that of the first material piece 111. In this fitted state, since the first material piece 111 differs in wall thickness from the second material piece 112, a difference in height is generated between the material pieces 111 and 112 at the position of the peripheral edge of the fitted hole 112b of the second material piece 112 on the upper surfaces of the material pieces 111 and 112 in the thickness direction as shown in FIG. 8(C). In FIG. 8(C), reference numeral 115 denotes the height difference section between the material pieces 111 and 112, and reference numeral 115a denotes the corner of this height difference section 115. In addition, reference numeral 114 denotes the fitted section between the first material piece 111 and the second material piece 112. Reference numeral 111a denotes the shoulder section of the first material piece 111 protruded from this fitted section 115 toward the upper surface side in the thickness direction.

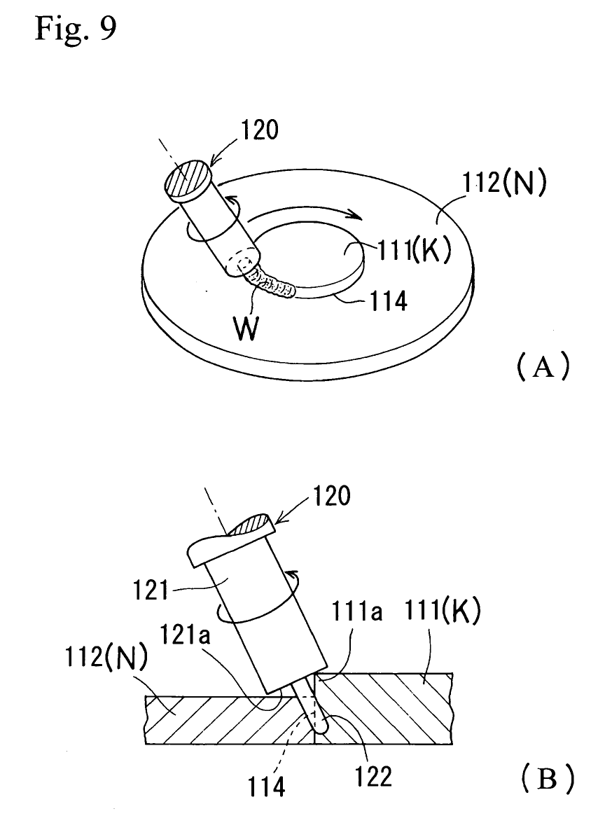

Next, in this fitted state, as shown in FIGS. 9(A) and 9(B), the outer peripheral edge of the first material piece 111 and that of the fitted hole 112b of the second material piece 112 are welded over the entire periphery by the friction stir welding. This friction stir welding will be described as follows.

Reference numeral 120 denotes a welding tool for friction stir welding which is comprised of a large-diameter cylindrical rotator 121 and a small-diameter pin probe 122 which is protruded from the rotating central section of the end face 121a of the rotator 121 along the rotation axis of the rotator 121 and integrated with the rotator 121. The rotator 121 and the probe 122 are formed out of materials harder than the material pieces 111 and 112 and resistant against frictional heat generated when the material pieces 111 and 112 are welded. In addition, a stirring convex section (not shown) which stirs the stocks of the material pieces 111 and 112 softened by the frictional heat is formed on the outer peripheral surface of the probe 122.

Using this welding tool 120, the rotator 121 and the probe 122 are rotated and the rotation axis is inclined relative to the material pieces 111 and 112 toward the second material piece 112. In this state, the probe 122 which is being rotated is embedded into the fitted section 114 between the material pieces 111 and 112 from the upper surface side and the end face 121a of the rotating rotator 111 is abutted on the shoulder section 111a of the first material piece 111 protruded from the fitted section 114. In this state, the probe 122 is moved relative to the material pieces 111 and 112 along the fitted section 114 to turn the probe 122 once.

Following this movement of the probe 122, the fitted section 114 is welded by the probe 122 at a probe embedded position progressively.

That is, the material pieces 111 and 112 are softened in the vicinity of the probe embedded position by frictional heat generated by the rotation of the probe 122 and that generated by the sliding of the end face 121a of the rotator 121 on the shoulder section 111a of the first material piece 111. In addition, the shoulder section 111a of the first material piece 111 is plastically deformed so that the surface of the shoulder section 111a is inclined in response to a pressure force from the end face 121a of the rotator 121, and the stock of the shoulder section 111a is filled into the corner 115a of the height difference section 115.

As can be seen, the stocks of the material pieces 111 and 112 are stirred and mixed in response to the rotating force of the probe 122 while the shoulder section 111a of the first material piece 111 is plastically deformed. In addition, the stocks of the material pieces 111 and 112 plastically flow so as to fill up a groove through which the probe 122 passes in response to the progressive pressure of the probe 122. Thereafter, the stocks rapidly lose frictional heat and cool and solidify. The phenomena are sequentially repeatedly at the probe embedded position following the movement of the probe 122. Finally, the fitted sections 114 of the material pieces 111 and 112 are welded over the entire periphery, and the material pieces 111 and 112 are integrated with each other in the fitted sections, thereby obtaining the material 110 shown in FIG. 10.

Since the first material piece 111 and the second material piece 112 of the material 110 thus obtained are welded and integrated by the friction stir welding, deformations such as thermal distortions following the welding hardly occur.

By conducting deep drawing on this material 110 by a well-known deep drawer comprising a punch and a die using this material so that the first material piece 111 and the second material piece 112 are formed into the bottom wall section 102 and the peripheral wall section 103 of the bottomed cylindrical body 101, respectively, the bottomed cylindrical body 101 shown in FIG. 7 is obtained. The welded section W is formed on the outer peripheral edge of the bottom wall section 102 of this bottomed cylindrical body 101.

When this deep drawing is performed, the shoulder section 111a of the first material piece 111 of the material 110 is plastically deformed and the surface of the shoulder section 111a is thereby formed as an inclined surface which strides over the upper surface of the first material piece 111 and that of the second material piece 112 as shown in FIG. 10(C). Therefore, the concentration of stress which may occur at the height difference section (see FIG. 8(C), reference numeral 115) when the material 110 is subjected to deep drawing is eased. In addition, since the material 110 is formed by welding and integrating the first material piece 111 and the second material piece 112 by the friction stir welding, the material is extremely low in the deterioration of the mechanical characteristics due to the welding heat and the welded section W and a region in the vicinity of the welded section W have good workability. Accordingly, even if deep drawing is conducted on this material 110, a formation defect such as a crack which may occur in the vicinity of a bent section which connects the bottom wall section 102 to the peripheral wall section 103 or the welded section W does not occur, making it possible to easily conduct the deep drawing. As a result, the bottomed cylindrical body 101 having excellent quality can be formed. Due to this, the bottomed cylindrical body 101 thus formed can be particularly suitable for a pressure vessel which contains a pressure fluid.

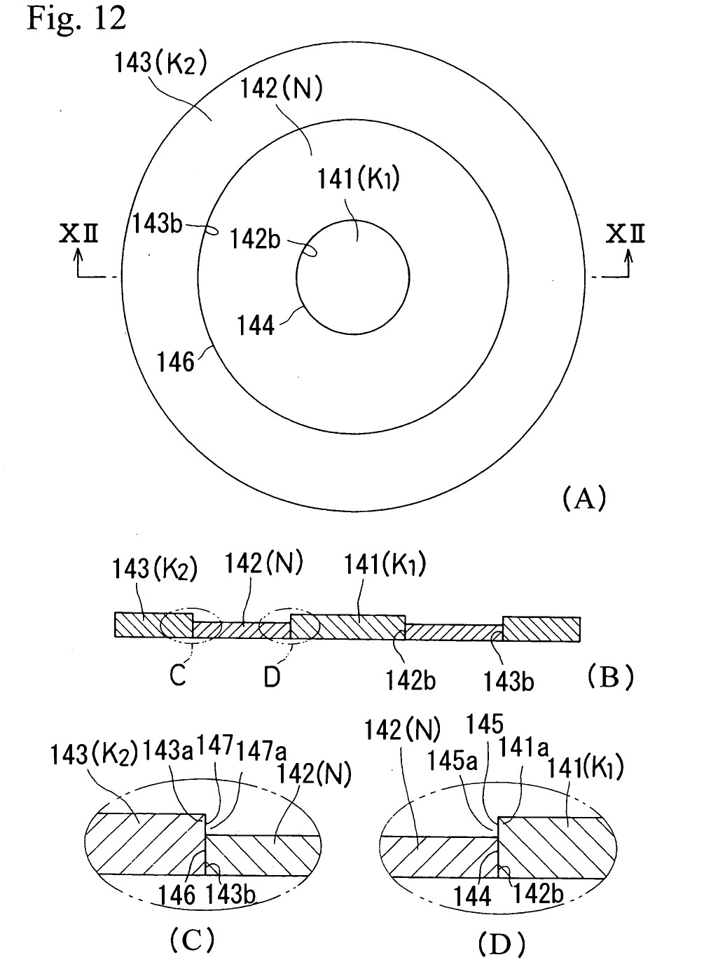

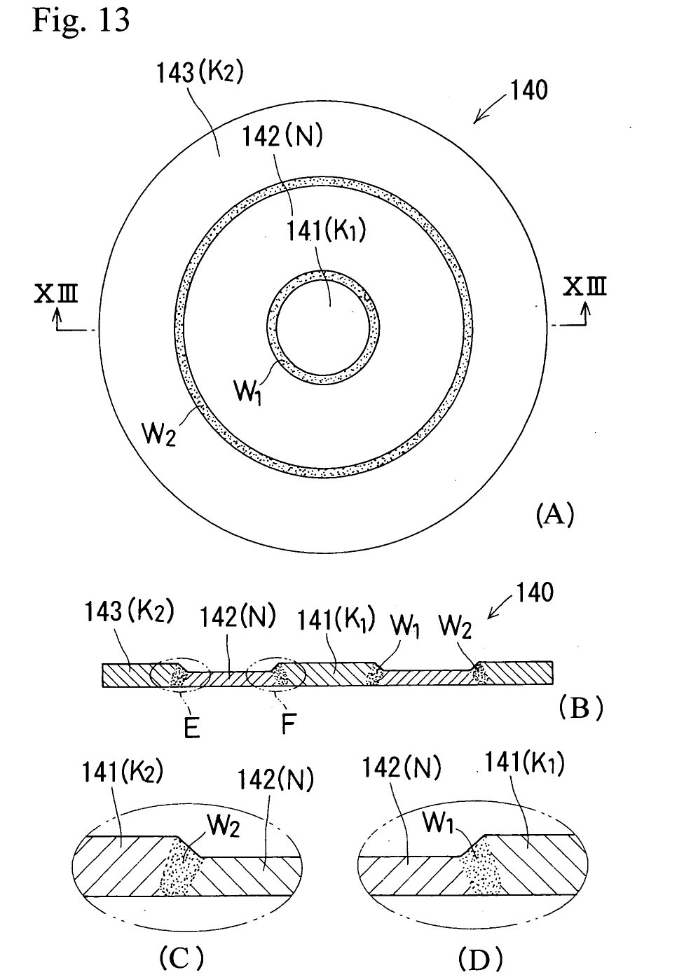

FIG. 13 shows the second mode for working the plastic work plate material according to the second feature of the present invention. FIG. 12 shows a bottomed cylindrical body formed out of the material. The material and the bottomed cylindrical body will be described while focusing on the difference of the second mode from the first mode already stated above.

The bottomed cylindrical body 131 shown in FIG. 12 is made of aluminum or aluminum alloy and is comprised of a thick, disc-like bottom wall section 132, a thin, cylindrical peripheral wall section 133 integrally formed on the outer peripheral edge of the bottom wall section 132 and a thick, dome-like top wall section 134 integrally formed on the peripheral edge of the upper end of the peripheral wall section 133. A circular hole 134a is formed in the top portion of the top wall section 134. This bottomed cylindrical body 131 is formed by subjecting a material 140 to deep drawing and spinning.

As shown in FIGS. 13(A) and 13(B), the material 140 is entirely formed into a disc, a first wall thick section K1 is formed in the central section of the material 140, a thin wall section N is formed around the first thick wall section K1, and a second thick wall section K2 is formed around the thin wall section N. As shown in FIGS. 12(A) and 12(B), the first thick wall section K1 is formed out of a thick, disc-like first material piece 141 made of aluminum or aluminum alloy. The thin wall section N is formed out of a thin, annular plate-like second material piece 142 made of aluminum or aluminum alloy and has a disc-like first material piece fitted hole 142b provided in a central section thereof. The second thick wall section K2 is formed out of a thick, annular plate-like third material piece 143 made of aluminum or aluminum alloy and has a disc-like second material piece fitted hole 143b formed in a central section thereof.

As for this material 140, the first material piece 141 is a region which forms the bottom wall section 132 of the bottomed cylindrical body 131 and has a wall thickness of, for example, 5 mm, and a material made of, for example, A5083. The second material piece 142 is a region which forms the peripheral wall section 133 of the bottomed cylindrical body 131 and has a wall thickness of, for example, 3 mm, and a material made of, for example, A5083. The third material piece 143 is a region which forms the top wall section 134 of the bottomed cylindrical body 131 and has a wall thickness of, for example, 5 mm, and a material made of, for example, A5083. The second material piece 142 is exactly fitted into the fitted hole 143b of the third material piece 143 and the first material piece 141 is exactly fitted into the fitted hole 142b of the second material piece 142. In this fitted state, the outer peripheral edge of the first material piece 141 and that of the fitted hole 142b of the second material piece 142 are welded over the entire periphery by friction stir welding, whereby the first material piece 141 is integrated with the second material piece 142. In addition, the outer peripheral edge of the second material piece 142 and that of the fitted hole 143b of the third material piece 143 are welded over the entire periphery by the friction stir welding, whereby the second material piece 142 is integrated with the third material piece 143.

This material 140 is manufactured as follows.

Namely, as shown in FIGS. 12(A) and 12(B), the second material piece 142 is fitted into the fitted hole 143b of the third material piece 143 mounted on a welding bed (not shown) so that the lower surface of the third material piece 143 is flush with the lower surface of the second material piece 142. In this fitted state, since the second material piece 142 differs in wall thickness from the third material piece 143, a difference in height is generated between the material pieces 142 and 143 at the position of the peripheral edge of the fitted hole 143b of the third material piece 143 on the upper surfaces of the material pieces 142 and 143 in the thickness direction to correspond to a difference in wall thickness therebetween as shown in FIG. 12(C). In FIG. 12(C), reference numeral 147 denotes a height difference section between the material pieces 142 and 143 and reference numeral 147a denotes the corner of this height difference section 147. In addition, reference numeral 146 denotes the fitted section between the second material piece 142 and the third material piece 143. Reference numeral 143a denotes the shoulder section of the third material piece 143 protruded from this fitted section 146 toward the upper surface side in the thickness direction. Furthermore, the first material piece 141 is fitted into the fitted hole 142b of the second material piece 142 so that the lower surface of the second material piece 142 is flush with that of the first material piece 141. In this fitted state, since the first material piece 141 differs in wall thickness from the second material piece 142, a difference in height is generated between the material pieces 141 and 142 at the position of the peripheral edge of the fitted hole 142b of the second material piece 142 on the upper surfaces of the material pieces 141 and 142 in the thickness direction to correspond to a difference in wall thickness therebetween as shown in FIG. 12(D). In FIG. 12(D), reference numeral 145 denotes the height difference section between the material pieces 141 and 142 and reference numeral 145a denotes the corner of this height difference section 145. In addition, reference numeral 144 denotes the fitted section between the first material piece 141 and the second material piece 142. Reference numeral 141a denotes the shoulder section of the first material piece 141 protruded from this fitted section 144 toward the upper surface side in the thickness direction.

Next, in this fitted state, using the welding tool (see FIG. 9, reference numeral 120) for friction stir welding shown in the first mode stated above, the outer peripheral edge of the second material piece 142 and that of the fitted wall 143b of the third material piece 143 are welded over the entire periphery by friction stir welding, thereby integrating the third material piece 143 with the second material piece 142. Furthermore, the outer peripheral edge of the first material piece 141 and that of the fitted wall 142b of the second material piece 142 are welded over the entire periphery by the friction stir welding, thereby integrating the second material piece 142 with the first material piece 141. This friction stir welding is performed by the same welding operation and welding procedures as those in the first mode, and description thereof will not be repeated herein.

In the material 140 thus obtained, since the first material piece 141 and the second material piece 142 are welded and integrated by the friction stir welding, deformations such as thermal distortions caused by the welding hardly occur. Likewise, since the second material piece 142 and the third material piece 143 are welded and integrated by the friction stir welding, deformations such as thermal distortions caused by the welding hardly occur.

Using this material 140, deep drawing is conducted thereon by a well-known deep drawer comprising a punch and a die so that the first material piece 141 and the second material piece 142 become the bottom wall section 132 and the peripheral wall section 133 of the bottomed cylindrical body 131, respectively. Furthermore, spinning is conducted on the material 140 by a well-known spinner so that the third material piece 132 becomes the top wall section 134 of the bottomed cylindrical body 131. As a result, the bottomed cylindrical body 131 shown in FIG. 1 is formed. In this bottomed cylindrical body 131, a welded section W1 in which the first material piece 141 is welded to the second material piece 142 is formed on the outer peripheral edge of the bottom wall section 132 and a welded section W2 in which the second material piece 142 is welded to the third material piece 143 is formed on the outer peripheral edge of the top wall section 134.

When the deep drawing is performed, the shoulder section 141a of the first material piece 141 of the material 140 is plastically deformed, whereby the surface of the shoulder section is formed into an inclined surface which strides over the upper surface of the first material piece 141 and that of the second material piece 142 as shown in FIG. 13(D). Therefore, when the material 140 is subjected to the deep drawing, the concentration of stress which may occur to the height difference section (see FIG. 12(D), reference numeral 145) when subjecting the material 140 to the deep drawing is eased. In addition, since the material 140 is formed by welding and integrating the first material piece 141 and the second material piece 142 by the friction stir welding, the welded section W1 and a region in the vicinity of the welded section W1 have good workability. Accordingly, even if deep drawing is conducted on this material 140, a formation defect such as a crack which may occur in the vicinity of a bent section which connects the bottom wall section 132 to the peripheral wall section 133 or the welded section W1 does not occur, making it possible to easily conduct the deep drawing. In addition, if spinning is conducted, since the shoulder section 143a of the third material piece 143 of the material 140 is plastically deformed and the surface of the shoulder section is formed into an inclined surface which strides over the upper surface of the second material piece 142 and that of the third material piece 143 as shown in FIG. 13(C), the concentration of stress which may occur to the height difference section (see FIG. 12(C), reference numeral 147) when subjecting the material 140 to the spinning is eased. Furthermore, since the material 140 is formed by welding and integrating the third material piece 143 and the second material piece 142 by the friction stir welding, the welded section W2 and a region in the vicinity of the welded section W2 have good workability. Accordingly, even if spinning is conducted on this material 140, a working defect, such as a crack which may occur in the vicinity of a bent section which connects the peripheral wall section 133 to the top wall section 134 and the welded section W2, does not occur, making it possible to easily conduct the spinning. As a result, the bottomed cylindrical body 131 having excellent quality can be formed. Therefore, the bottomed cylindrical body 131 thus formed can be suited particularly as a pressure vessel which contains a pressure fluid.

The first and second modes according to the second feature of the present invention have been described thus far. However, the present invention is not limited to these modes, and can be variously set and modified.

For example, while the bottomed cylindrical bodies 101 and 131 in the above-stated modes are cylindrical, the bottomed cylindrical body according to the present invention may be rectangular column shaped. Likewise, while the materials 110 and 140 in the above-stated modes are disc-like materials, the material according to the present invention may be a rectangular plate material.

While the materials 110 and 140 in the above-stated modes are subjected to drawing such as deep drawing or spinning, the material according to the present invention may be subjected to the other plastic working.

Moreover, the material according to the present invention may be constituted out of a plurality of metallic material pieces not only made of the same material but also made of different materials. In this way, even if the material is constituted out of a plurality of material pieces made of different materials, the friction stir welding can advantageously ensure good welding of the different metallic materials, so that it is possible to provide a material having good welded state.

Embodiments of the First Feature

Next, the concrete embodiments of the first feature of the present invention will be described.

First Embodiment

As the first welding target member 1, a plane aluminum alloy material (made of A6063-T5, wall thickness t1=1.0 mm) was prepared. As the second welding target member 2, a plane aluminum alloy material (made of A5052-H34, wall thickness t2=2.0 mm) was prepared.

It is normally known that if the average deformation resistance of the 6063-T5 in the temperature range of 400 to 550° is compared with that of the 5052-H34 in the same temperature range, the average deformation resistance of the 5052-H34 is higher. In the same temperature range, therefore, if the total high temperature deformation resistance of the first welding target member 1 is compared with that of the second welding target member 2, the total high temperature deformation resistance of the second welding target member 2 is higher.

Next, as in the case of the above-stated mode, the welding target members 1 and 2 were contacted against each other so that the rear surfaces thereof were flush with each other. The rotating direction of the rotator 11 of the welding tool 10 was set in the direction L in which the rotator 11 rotated from the second welding target member 2 to the first welding target member 1 in the rear of the welding direction M and the welding target members 1 and 2 were subjected to contact welding in accordance with the welding procedures shown in the above-stated mode.

### Comparison Example 1

The rotating direction of the rotator 11 of the welding tool 10 was set in the direction R in which the rotator 11 rotates from the first welding target member 1 to the second welding target member 2 in the rear of the welding direction M and the welding target members 1 and 2 were subjected to contact welding. The welding target members to be used and the other welding conditions are the same as those in the First Embodiment.

Second Embodiment

As the first welding target member 1, a plane aluminum alloy material (made of A5083-H34, wall thickness t1=1.0 mm) was prepared. As the second welding target member 2, a plane aluminum alloy material (made of A6063-T5, wall thickness t2=3.0 mm) was prepared.

If the average deformation resistance of the 5083-H34 in the temperature range of 400 to 550° C. is compared with that of the 6063-T5 in the same temperature range, the average deformation resistance of the 5083-H34 is higher. However, if the wall thicknesses of the both materials are also considered, the total high temperature deformation resistances of the respective welding target members are calculated and the total high temperature deformation resistance of the first welding target member 1 and that of the second welding target member 2 are compared in the same temperature range, then the total high temperature deformation resistance of the second welding target member 2 is higher.

Next, as in the case of the above-stated mode, the welding target members 1 and 2 were contacted against each other so that the rear surfaces thereof were flush with each other. The rotating direction of the rotator 11 of the welding tool 10 was set in the direction L in which the rotator 11 rotated from the second welding target member 2 to the first welding target member 1 in the rear of the welding direction M and the welding target members 1 and 2 were subjected to contact welding in accordance with the welding procedures shown in the above-stated mode.

Welding Results

Cross sections of the welded sections of contact welded joints obtained in the First Embodiment, the Second Embodiment, and the first comparison were examined with a microscope so as to evaluate respective welded states.

As a result, it was found that many tunnel welding defects occurred in the vicinity of the advanced edge of the welded section W of the contact welded joint obtained in the Comparison Example 1.

As for the contact welded joints obtained in the first and Second Embodiments, by contrast, no tunnel welding defects occurred not only in the vicinity of the retreating edge of the welded section W of each joint, but also in the vicinity of the advanced edge thereof. It was, therefore, possible to determine that a good welded section can be formed according to the present invention.

Embodiments of the Second Feature

First Embodiment

To form the bottomed cylindrical body 1 in the first mode for carrying out the second feature of the present invention by deep drawing, the first material 11 having a wall thickness of 5 mm and made of A5083 and the second material 12 having a wall thickness of 3 mm and made of A5083 were prepared. The first material 111 and the second material 112 were welded and integrated by friction stir welding in accordance with the welding operation and procedures in the first mode for carrying out the second feature of the present invention, whereby the deep drawing target member 110 was manufactured. Next, by subjecting this material 110 to deep drawing, the bottomed cylindrical body 101 was formed.

### Comparison Example 1

The first material and the second material were welded and integrated by MIG welding, whereby a deep drawing target member was manufactured. Next, by subjecting this material to deep drawing, a bottomed cylindrical body was formed. The other formation conditions are the same as those in the First Embodiment.

### Comparison Example 2

The first material and the second material were welded and integrated by laser beam welding, whereby a deep drawing target member was manufactured. Next, by subjecting this material to deep drawing, a bottomed cylindrical body was formed. The other formation conditions are the same as those in the First Embodiment.

The deformation states and deep drawing workability of the materials manufactured in the First Embodiment and the first and second comparisons were examined. The reason is shown in Table 1.

TABLE 1

| | Welding means | Deformation state | Workability |
|---|---|---|---|
| First Embodiment | Friction stir welding | ∘ | ∘ |
| Comparison | MIG welding | x | x |
| Example 1 | | | |
| Comparison | Laser beam welding | Δ | x |
| Example 2 | | | |

In the deformation state columns in Table 1, symbol O denotes extremely small deformation, Δ denotes slightly large deformation, and × denotes extremely large deformation. Furthermore, in the workability columns, O denotes good workability and × denotes poor workability.

As can be seen from Table 1, the material of the first comparison has an extremely large deformation caused by the welding and poor workability. The material of the second comparison has a slightly large deformation caused by the welding and poor workability. The material of the First Embodiment, by contrast, has extremely small deformation caused by the welding and has good workability.

1. A friction stir welding method for conducting contact welding on two welding target members, the method comprising:
using a welding tool having a rotatable welding head;
preparing two welding target members having different high temperature deformation resistances;
contacting the two welding target members against each other so as to generate a difference in height on a surface side in a thickness direction;
arranging the rotating welding head to be embedded into a contact section of the two welding target members or a neighborhood of the contact section from the surface side;
relatively moving the welding head to the two welding target members along the contact section in the above condition;
setting a rotating direction of the welding head in a direction in which the welding head rotates from the welding target member higher in high temperature deformation resistance to the welding target member lower in high temperature deformation resistance rearward of a welding direction; thus
conducting the contact welding on the two welding target members.

2. A friction stir welding method for conducting contact welding on two welding target members, the method comprising:
using a welding tool having a rotatable welding head;
preparing a first welding target member having a high temperature deformation resistance of Y1 and a wall thickness of to and a second welding target member having a high temperature deformation resistance of Y2 (Y2≠Y1) and a wall thickness of t2;
contacting the two welding target members against each other so as to generate a difference in height on a surface side in a thickness direction;
arranging the rotating welding head to be embedded into a contact section of the two welding target members or a neighborhood of the contact section from a surface side;
relatively moving the welding head to the two welding target members along the contact section in the above condition;
setting a rotating direction of the welding head in a direction in which the welding head rotates from the first welding target member to the second welding target member rearward of a welding direction when the two welding target members are contacted against each other while satisfying a relational expression of Y2×t2<Y1×t1;
setting the rotating direction of the welding head in a direction in which the welding head rotates from the second welding target member to the first welding target member rearward of the welding direction when the two welding target members are contacted against each other while satisfying a relational expression of Y2×t2>Y1×t1; thus
conducting the contact welding on the two welding target members.

3. A friction stir welding method according to claim 1 or 2, wherein
the welding head of said welding tool consists of a small-diameter probe protruded from an end face of a large-diameter rotator,
the rotating rotator is arranged in a state in which a rotation axis of the rotator is inclined relatively to the two welding target members toward the welding target member at a lower position and in a state in which an end face of the rotating rotator is pressure-welded to a shoulder section of the welding target member at a higher position protruded from the contact section, thus
the contact welding is conducted in this state.

4. A friction stir welding method for conducting contact welding on two welding target members, the method comprising:
using a welding tool having a rotatable welding head consisting of a small-diameter probe protruded from an end face of a large-diameter rotator;
preparing a first welding target members having a high temperature deformation resistance of Y1 and a wall thickness of to and a second welding target member having a high temperature deformation resistance of Y2 (Y2≠Y1) and a wall thickness of t2;
contacting the two welding target members against each other so as to generate a difference in height on a surface side in a thickness direction by arranging the second welding target members at higher position;
satisfying the two welding target members with a relational expression of Y2×t2>Y1×t1 in this contacted state;
arranging the rotating probe to be embedded into a contact section of the two welding target members or a neighborhood of the contact section from a surface side;
arranging the rotating rotator in a state in which a rotation axis of the rotator is inclined relatively to the two welding target members toward the first welding target member;
arranging the rotating rotator in a state in which an end face of the rotating rotator is pressure-welded to a shoulder section of the second welding target member protruded from the contact section;
relatively moving the probe to the two welding target members along the contact section in the above condition;
setting a rotating direction of the welding head in a direction in which the welding head rotates from the second welding target member to the first welding target member rearward of a welding direction; thus
conducting the contact welding on the two welding target members.

5. A plastic work plate material characterized by comprising a thick wall section and a thin wall section, and the thick wall section and the thin wall section are welded and integrated by friction stir welding.

6. A plastic work plate material according to claim 5,
said thin wall section is formed around said thick wall section, said thick wall section is a region for forming a bottom wall section or a top wall section, and said thin wall section is a region for forming a peripheral wall section.

7. A bottomed cylindrical body characterized by being formed by plastically working the plastic work plate material according to claim 5 or 6.
